(19) United States
(12) Patent Application Publication
(10) Pub. No.: US 2016/0165605 A1
(43) Pub. Date: Jun. 9, 2016

(54) NETWORK ASSISTED MMWAVE BEAM SYNCHRONIZATION AND ALIGNMENT

(71) Applicant: Intel Corporation, Santa Clara, CA (US)

(72) Inventors: KONSTANTINOS D. DIMOU, Santa Clara, CA (US); SHILPA TALWAR, Los Altos, CA (US)

(21) Appl. No.: 14/562,592

(22) Filed: Dec. 5, 2014

(51) Int. Cl. H04W 72/04; H04W 4/02; H04W 56/00; H04B 7/06

(52) U.S. Cl. CPC H04W 72/0453; H04B 7/0617; H04W 4/026; H04W 56/001

(57) ABSTRACT

Embodiments of the present disclosure describe apparatuses and methods for network assisted mmWave beam synchronization and alignment. Various embodiments may include an evolved Node B (eNB). The eNB may include processing circuitry to estimate directional information of an mmWave frequency beam from the eNB in reference to a user equipment (UE) based on positional information of the UE obtained based on a connection between the eNB and the UE in a microwave frequency band. Other embodiments may be described and/or claimed.

### FIELD

Embodiments of the present disclosure generally relate to the field of wireless communication, and more particularly, to apparatuses and methods for network assisted mmWave beam synchronization and alignment.

### BACKGROUND

The background description provided herein is for generally presenting the context of the disclosure. Unless otherwise indicated herein, the materials described in this section are not prior art to the claims in this application and are not admitted to be prior art or suggestions of the prior art by inclusion in this section.

Extremely high frequency (EHF) is for the band of radio frequencies in the electromagnetic spectrum from 30 to 300 gigahertz. Radio waves in this band have wavelengths from ten to one millimeter, thus known as millimeter band, millimeter wave, or mmWave. mmWave may have high atmospheric attenuation. For example, mmWave may be blocked by building walls, diffracted by building edges, and reflected by small metal surfaces. Similar characteristics are observed for the higher frequencies of the Super High Frequency (SHF) band, namely for carrier frequency bands above 10 GHz up to 30 GHz.

The communication at mmWave carrier frequency and at frequencies close to them may be characterized by very high path loss attenuation, which may require a high number of antennas and hence antenna gains so as to combat this high path loss. The existence of a high number of antennas leads into the forming of narrow directive beams pointing to the target. Such narrow beam forming may be necessary so that mmWave frequency signals can reach the same coverage levels as the ones observed at microwave frequencies. However, this new link paradigm with mmWave may pose several challenges in the system design, such as synchronization and beam alignment for the initial communication between a base station (BS) and a user equipment (UE).

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 schematically illustrates a wireless communication system including mmWave in accordance with various embodiments.

FIG. 2 is a schematic block diagram illustrating components of an evolved Node B (eNB) and a user equipment (UE) in the wireless communication system in accordance with various embodiments.

FIG. 3 is a flowchart illustrating a process for network assisted mmWave beam synchronization and alignment in accordance with various embodiments.

FIG. 4 is a flowchart illustrating another process for network assisted mmWave beam synchronization and alignment in accordance with various embodiments.

FIG. 5 is a flowchart illustrating another process for network assisted mmWave beam synchronization and alignment in accordance with various embodiments.

FIG. 6 is a block diagram of an example computing device that may be used to practice various embodiments described herein.

FIG. 7 illustrates an article of manufacture having programming instructions, incorporating aspects of the present disclosure, in accordance with various embodiments.

### DETAILED DESCRIPTION

Embodiments of the present disclosure describe apparatuses and methods for network assisted mmWave beam synchronization and alignment. In various embodiments, an evolved Node B (eNB) may include processing circuitry to estimate directional information of an mmWave frequency beam from the eNB in reference to a user equipment (UE) based on positional information of the UE obtained based on a connection between the eNB and the UE in a microwave frequency band. Further, the eNB may include transceiver circuitry, coupled to the processing circuitry, to send the directional information to the UE. These and other aspects of the present disclosure will be more fully described below.

In the following detailed description, reference is made to the accompanying drawings, which form a part hereof wherein like numerals designate like parts throughout, and in which is shown by way of illustration embodiments that may be practiced. It is to be understood that other embodiments may be utilized and structural or logical changes may be made without departing from the scope of the present disclosure.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality.

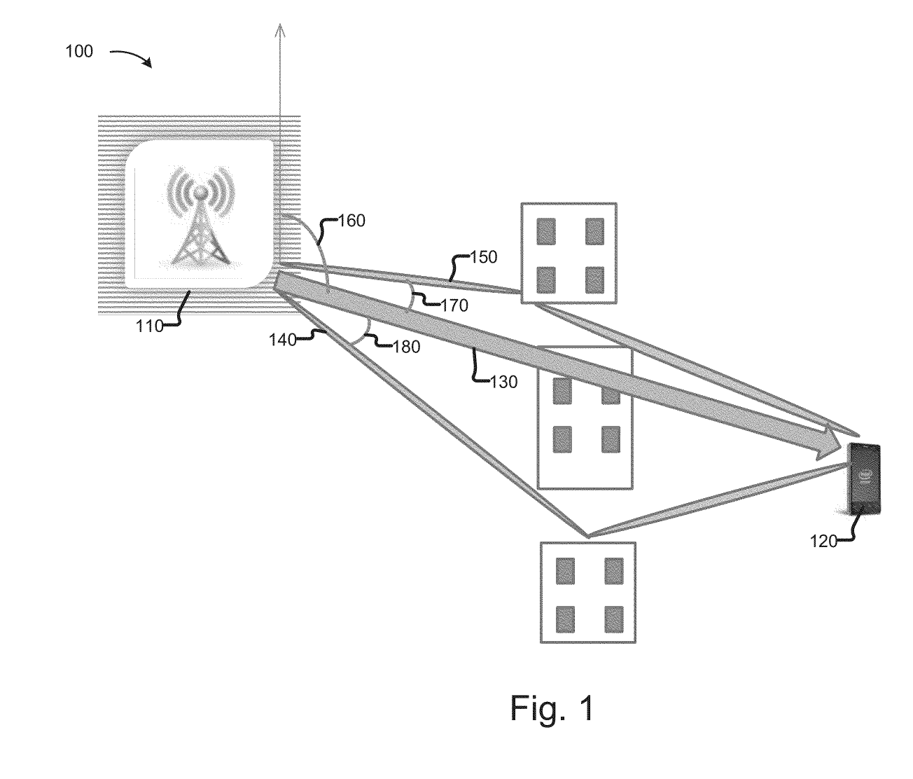

FIG. 1 schematically illustrates a wireless communication system 100 including mmWave in accordance with various embodiments. The wireless communication system 100 may include base station (BS) 110 and UE 120 to communicate at mmWave carrier frequency as well as microwave frequencies.

In various embodiments, the wireless communication system 100 may include one or more radio access networks, such as a Global System for Mobile Communication (GSM), General Packet Radio Service (GPRS), Universal Mobile Telecommunications System (UMTS), High Speed Packet Access (HSPA), Evolved HSPA (E-HSPA), or Long-Term Evolution (LTE) network. In some embodiments, a radio access network may include GSM Enhanced Data rates for GSM Evolution (EDGE) Radio Access Network (GERAN), Universal Terrestrial Radio Access Network (UTRAN), or Evolved UTRAN (E-UTRAN). The wireless communication system 100 may operate in accordance with other network technologies in other embodiments.

Mobile communication technology may rely on various standards and protocols to transmit data between a base station and a wireless communication device. Wireless communication system standards and protocols may include, for example, the 3rd Generation Partnership Project (3GPP) LTE; the Institute of Electrical and Electronics Engineers (IEEE) 802.16 standard, which is commonly known to industry groups as worldwide interoperability for microwave access (WiMAX); and the IEEE 802.11 standard, which is commonly known as Wi-Fi. In a 3GPP radio access network (RAN), according to LTE, base station 110 may be referred to as an evolved Node B (also commonly denoted as eNodeB, or eNB). It may communicate with a wireless communication device, such as UE 120. For ease of illustration, various descriptions herein are provided to conform to 3GPP in the communication system 100; however, the subject matter of the present disclosure is not limited in this regard, and the embodiments disclosed herein may be advantageously applied to other wired or wireless communication protocols or networks.

In various embodiments, UE 120 may access base station 110 via a radio link 130, 140, or 150. In some embodiments, radio link 130 may be based on a microwave band. In some embodiments, radio link 140 or 150 may be based on an mmWave band. A downlink (DL) transmission may be a communication from base station 110 to UE 120. An uplink (UL) transmission may be a communication from UE 120 to base station 110. Only limited numbers of UEs and base stations are illustrated in FIG. 1 for ease of illustration. However, the communication system 100 may include any number of UEs, base stations, or other servers while practicing suitable embodiments of the present disclosure.

In some embodiments, narrow mmWave beams associated with link 140 or 150 may transmit in all directions stepwise, e.g., performing 360° azimuth sweeps over a given time window for mmWave frequency beam acquisition and synchronization between base station 110 and UE 120. Such embodiments are appropriate for low range systems, such as Wireless Gigabit Alliance (WiGig) systems, where UEs may be statistically located within a limited azimuth space. However, such embodiments may not be ideal for a cellular system in which UEs might be located over the whole azimuth range, and in which delay in beam and pilot acquisition may result in handover failures, e.g., handover from a microwave band to an mmWave band.

In various embodiments, wireless communication system 100 may have mmWave carrier frequency co-exist with microwave frequencies. In various embodiments, wireless communication system 100 may have mmWave carrier frequency co-exist with other cellular systems (not shown) operating at microwave frequencies. Microwave carrier frequencies, such as 3GPP Long Term Evolution (LTE) Advanced, may be used for general control functions, such as synchronization to the system, system information acquisition, cell association, mobility management. Meanwhile, microwave carrier frequencies may also be used to facilitate mmWave frequency beam acquisition and synchronization, e.g., in wireless communication system 100 featuring both microwave and mmWave frequency bands.

In various embodiments, base station 110 may indicate to UE 120 the rough direction to which mmWave frequency beams are pointed to UE 120. Such directional information may be used by UE 120 for mmWave frequency beam acquisition and synchronization. In some embodiments, UE 120 may have already been synchronized with base station 110 at microwave frequencies, and radio link 130 has already been established at microwave frequency. In such case, base station 110 may estimate such directional information based on the microwave frequency band. Further, base station 110 may indicate to UE 120 such directional information via signaling mechanisms based on the microwave frequency band.

The disclosed apparatuses and methods for a given connection switching carrier frequencies herein may be described in the context of 3GPP LTE Advanced, but such principles apply to other cellular systems. In various embodiments of handover procedures from microwave frequency to mmWave frequency, base station 110 may assist UE 120 for mmWave beam synchronization and alignment. The disclosure herein may focus on the case of switching from microwave frequency to mmWave frequency as a handover procedure, but such principles apply to any case in which a given connection switches carrier frequencies, e.g., in a carrier aggregation case, in which a given radio link switches from the primary carrier frequency to the secondary carrier frequency.

In some embodiments, UE 120 may be connected with base station 110 by using 3GPP technology such as 3GPP LTE Advanced. In this microwave frequency, the position of UE 120 and hence the azimuth angle of the UE position may be known to base station 110, e.g., based on 3GPP LTE positioning services. Similarly, among others, the azimuth angle to base station 110 may also be known to UE 120. As such, base station 110 may know the azimuth angle 160 of the location of UE 120. When base station 110 decided to hand over UE 120 to mmWave carrier frequency, base station 110 may inform UE 120's azimuth angle 160 with one or more margin angles (e.g., 170 or 180) in which base station 110 may direct to UE 120 mmWave synchronization signals or pilots. This directional information and other related information may be included in a handover preparation message and sent to UE 120 in the existing carrier frequency to facilitate beam acquisition and synchronization at mmWave carrier frequency.

In various embodiments, UE 120 may support multiple radio access technologies (RATs), e.g., 3GPP LTE Advanced (LTE A) based on 3GPP Release 10 specifications and a RAT operating in mmWave frequency bands, or close to them, e.g., at 12, 15, 24, 28 GHz or 38 GHz, or 60 GHz or 73 GHz or for any other carrier frequency above 12 GHz. The RAT operating at microwave frequency band may be used as the anchor system whose procedures may assist UE 120 to synchronize to base station 110, to listen to system information from base station 110 or another base station, to perform initial system access, to manage mobility and link establishment and maintenance.

When wireless communication system 100 decided to hand over UE 120 to another RAT operating at mmWave band, base station 110 may prepare and transmit a handover preparation message to UE 120. The handover preparation message may facilitate UE 120 to listen to mmWave band specific pilot symbols transmitted at a given direction. In various embodiments, the handover preparation message may include information of the given direction for UE 120 to listen to the mmWave band specific pilot symbols. Further, the handover preparation message may contain other information related to the mmWave band pilots, such as the pilot sequence characteristics, the carrier frequency, the frequency band, or the time window during which pilots are transmitted, among others.

As an example, at a given time instant, UE 120 may communicate with base station 110 via a RAT operating at a microwave frequency band (or bands below 10 GHz). For the purpose of illustration, the microwave frequency band is 3GPP Release 10 LTE Advanced and the operating frequency may be 2 GHz. UE 120 may be in a Radio Resource Control (RRC) connected mode, and UE 120 transmits and receives control and data from wireless communication system 100. In this case, UE 120 may be synchronized both in downlink and uplink with the network. Further, UE 120 may have acquired all the necessary system information. Meanwhile, base station 110 may have learned the UE's position, e.g., with the help of the 3GPP positioning mechanisms described in 3GPP Technical Specifications (TS) 23.032 (e.g., Rel-12, 2014 Sep. 17), 36.305 (e.g., Rel-12, 2014 Sep. 17), 36.355 (e.g., Rel-12, 2014 Sep. 17), 36.455 (e.g., Rel-12, 2014 Sep. 17). Namely, with the help of measurements described in 36.355 and 36.455, the position (or location) of a given UE may be known with fairly good accuracy at the network.

In various embodiments, base station 110 may determine the azimuth angle 160 of the UE location with regard to base station 110 or another fixed reference point, e.g., by combining the known positions of base station 110 and UE 120. The direction of propagation of a radio-frequency wave incident on an antenna array may be measured as angle of arrival (AoA). Within 3GPP LTE A, the AoA at a given UE may be known at the network. As an example, the AoA may be reported along with other measurements of Enhanced Cell ID (E-CID), e.g., specified in §9.2.5 of the 3GPP TS 36.455 “LTE Positioning Protocol (LPP) A,” version 11.3.0. Of course the AoA at microwave frequency band is not the same as the AoA at mmWave frequency; however, the AoA at microwave frequency band may statistically give an initial indication of the AoA at mmWave frequency. As illustrated in FIG. 1, the azimuth angle 160 of UE 120 to the North Pole may be known to base station 110 and/or UE 120. In some embodiments, downlink transmissions within 3GPP, e.g., in link 130, may be conducted with the aid of antenna arrays providing beams typically in the order of 30° or more.

When wireless communication system 100 decided to hand over UE 120 to an mmWave band, base station 110 may send a handover command to UE 120. In some embodiments, the RRC message RRCConnectionReconfiguration, e.g., in 3GPP TS 36.331, may be used to send the handover command. One or more new information elements (IEs) in the RRC message may be used to indicate where to search in the space domain for the downlink mmWave pilot symbols. As an example, the network may indicate to UE 120 the already known azimuth angle 160 of the UE's position to base station 110, and the margin angle range 170 and 180 around the azimuth angle 160.

In addition, the RRCConnectionReconfiguration message may include information related to the synchronization sequence or pilot to be transmitted. In some embodiments, the new RRCReconfiguration IEs may include a reason (e.g., move to mmWave), a microwave beam angle to a reference point (e.g., the North Pole), one or more angles around the microwave bean to transmit mmWave beams, the pilot sequence structure of the mmWave, or pilot sequence timing information. In some embodiments, the new RRCReconfiguration IEs may include a command to switch to another frequency with information of the indicated frequency, the azimuth angle of the UE to the serving base station, the margin angle space around the azimuth angle to be used as a search space for the mmWave beams. In some embodiments, the new RRCReconfiguration IEs may include the type of sequence to be used for mmWave, e.g., Zadoff-Chu, or Gold, or Barker; the sequence parameters, e.g., if Zadoff-Chu, root value, identity, etc.; the timing window during which the UE can try to synchronize; the time interval between synchronization signal (pilot) transmissions frequency of synchronization signals.

In one embodiment, contents of the modified RRCConnectionReconfiguration message for the handover from the RAT operating at microwave frequency to the RAT operating at mmWave frequency may include the following list of IEs.

List of Information Elements{

Existing IEs +
...
HandoverTommWaveRAT
mmWaveRATCarrierFrequency
currentAzimuthAngle
angleSpace
SynchronizationSequenceType
SynchronizationSequenceCharacteristics
Root
Shift
TransmissionWindow
TransmissionDuration
TransmissionInterval
TransmissionPeriod

}

In some embodiments, data transmission at the RAT operating at microwave frequency may continue until UE 120 is synchronized and beam aligned at the mmWave frequency. In this case, the procedure of handover from the lower frequency RAT to the higher frequency RAT is a soft handover procedure, e.g., establishment of the new mmWave RAT bearer may take place before releasing the microwave frequency RAT.

In some embodiments, UE 120 may inform the network, e.g., report to base station 110, about its successful synchronization and beam alignment at the mmWave carrier frequency. Such report may be transmitted by using RRC signaling at microwave carrier frequency. In some embodiments, such report may contain the AoA of the mmWave frequency band beams, e.g., in an information element in the RRC message.

Network assisted mmWave beam synchronization and alignment may reduce the mmWave beam acquisition time for UE 120. Further, network assisted mmWave beam synchronization and alignment may result in reduced energy consumption for both base station 110 and UE 120. As an example, UE 120 may be synchronized at mmWave frequency band and get beam alignment just before making use of the mmWave system, which saves UE 120 from maintaining the beam alignment within the mmWave frequency, which may be required if UE 120 were to get synchronization and beam alignment through its own initiative. As an example, if UE 120 decides to listen to mmWave frequency pilot symbols through its own initiative, then UE 120 may have to maintain the beam alignment within the mmWave frequency for a long period before UE 120 indeed communicates at this frequency band. However, maintaining alignment of these narrow mmWave band beams is a strenuous task consuming much energy. Therefore, it is advantageous for UE 120 to rely on network assisted mmWave beam synchronization and alignment just before making use of the mmWave system.

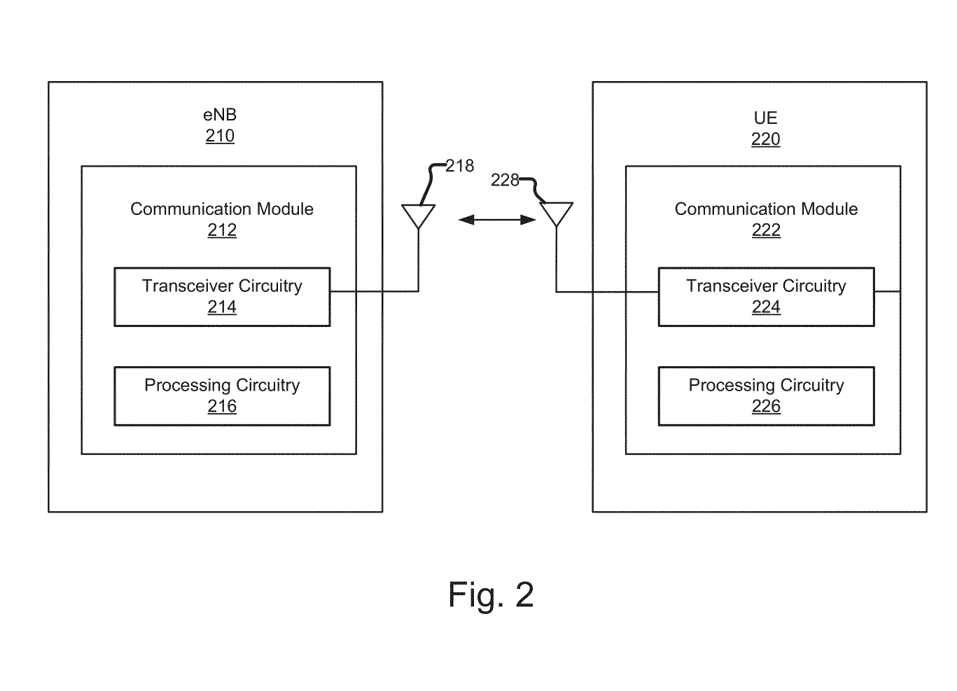

FIG. 2 is a schematic block diagram illustrating components of an eNB 210 and a UE 220 in a wireless communication environment in accordance with various embodiments.

The eNB 210 may be similar to, and substantially interchangeable with, base station 110 of FIG. 1. In embodiments, the eNB 210 may include one or more antennas 218 and communication module 212. In various embodiments, transceiver circuitry 214 and processing circuitry 216 within the communication module 212 may be coupled with each other as shown. Likewise, the UE 220 may be similar to, and substantially interchangeable with, UE 120 of FIG. 1. In embodiments, the UE 220 may include one or more antennas 228 and communication module 222. In various embodiments, transceiver circuitry 224 and processing circuitry 226 within the communication module 222 may be coupled with each other as shown.

The transceiver circuitry 214 may be coupled with the antennas 218 to facilitate over-the-air communication of signals to/from the eNB 210. Operations of the transceiver circuitry 214 may include, but are not limited to, filtering, amplifying, storing, modulating, demodulating, transforming, etc. In various embodiments, the transceiver circuitry 214 may be configured to provide various signal processing operations on the signal to the antennas 218 with appropriate characteristics. In some embodiments, the transceiver circuitry 214 may be configured to communicate with UE 220 in microwave frequency as well as mmWave frequency.

The transceiver circuitry 214 may be configured to receive signals from the antennas 218 for transmission to other components of the eNB 210 and/or for internal processing by the processing circuitry 216. In some embodiments, the processing circuitry 216 may estimate directional information of a millimeter wave (mmWave) frequency beam from eNB 210 in reference to UE 220 based on positional information of UE 220 obtained based on a connection between eNB 210 and UE 220 in a microwave frequency band. The transceiver circuitry 214 may further send the directional information to UE 220 in some embodiments.

The processing circuitry 216 may generate configuration and control information to UE 220. The configuration and control information may include, for example, downlink channel information, downlink control information (DCI), Radio Resource Control (RRC) configuration information, etc. In some embodiments, such configuration and control information may include a handover preparation message to UE 220 to facilitate a handover from a microwave carrier frequency to an mmWave carrier frequency. In some embodiments, the handover preparation message may include information of an mmWave synchronization sequence to be transmitted to UE 220 to facilitate mmWave beam synchronization and alignment at UE 220. In some embodiments, processing circuitry 216 may modify an RRCConnectionReconfiguration message to be transmitted to the UE to include the handover preparation message in one or more information elements of the RRCConnectionReconfiguration message.

Similar to the communication module 212, the communication module 222 may be coupled with the antennas 228 to facilitate over-the-air communication of signals between UE 220 and eNB 210 or between UE 220 and another UE. For example, the transceiver circuitry 224 may be configured to provide various signal processing operations on the signal to the antennas 228 with suitable characteristics. In various embodiments, operations of the transceiver circuitry 224 may include, but are not limited to, filtering, amplifying, storing, modulating, demodulating, transforming, etc.

The transceiver circuitry 224 may be configured to receive signals from the antennas 218, and then transmit the signals to other components of the UE 220 and/or for internal processing by the processing circuitry 226. In some embodiments, transceiver circuitry 224 may receive a handover preparation message from eNB 210 for UE 220 to hand over from a microwave band to an mmWave band. In some embodiments, transceiver circuitry 224 may receive such handover preparation message in a microwave frequency band, and the handover preparation message may include directional information related to an mmWave frequency beam with mmWave synchronization signals from eNB 210.

In some embodiments, in response to the handover preparation message, the processing circuitry 226 may facilitate the synchronization with eNB 210 at an mmWave frequency based on the handover preparation message received from eNB 210. In some embodiments, the transceiver circuitry 224 may further transmit a Radio Resource Control (RRC) message to eNB 210 to indicate whether the synchronization and beam alignment at the mmWave frequency is achieved.

In some embodiments, the UE 220 may include one or more antennas 228 to concurrently utilize radio resources of multiple respective component carriers. For example, the UE 220 may be configured to communicate using Orthogonal Frequency Division Multiple Access (OFDMA) (in, e.g., downlink communications) and/or Single-Carrier Frequency Division Multiple Access (SC-FDMA) (in, e.g., uplink communications). In some embodiments, the UE 220 may use the transceiver circuitry 224 to communicate with another UE via LTE ProSe or LTE Direct.

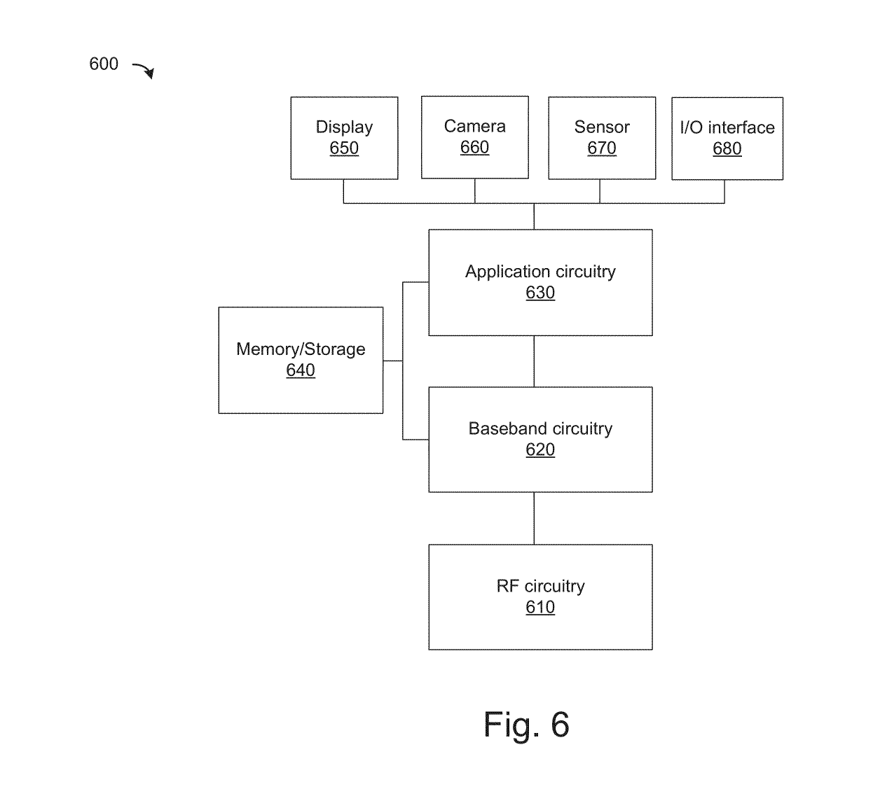

Some or all of the transceiver circuitry 224 and/or processing circuitry 226 may be included in, for example, radio frequency (RF) circuitry or baseband circuitry as described below with respect to FIG. 6. In various embodiments, the UE 220 may be, may include, or may be included in a single sensor device, a cellular telephone, a personal computer (PC), a notebook, an ultrabook, a netbook, a smartphone, an ultra mobile PC (UMPC), a handheld mobile device, a universal integrated circuit card (UICC), a personal digital assistant (PDA), a Customer Premise Equipment (CPE), a tablet computing device, or other consumer electronics such as MP3 players, digital cameras, and the like. In some embodiments, the UE may include a mobile station, as defined by IEEE 802.16e (2005 or 802.16m (2009) or some other revision of the IEEE 802.16 standard, or user equipment, as defined by 3GPP LTE Release 8 (2008), Release 9 (2009), Release 10 (2011), Release 12 or Release 13 (under development), or some other revision or release of the 3GPP LTE standards.

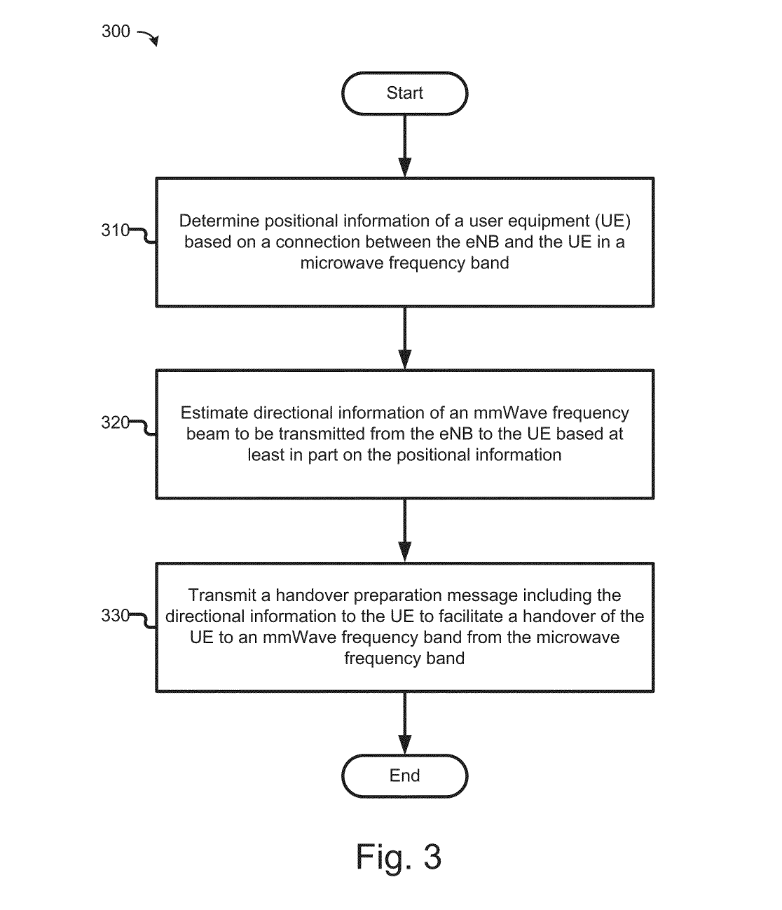

FIG. 3 is a flowchart illustrating a process for network assisted mmWave beam synchronization and alignment in accordance with various embodiments. The process 300 may be performed by a base station, e.g., base station 110 of FIG. 1, or by an eNB, e.g., eNB 210 of FIG. 2. In various embodiments, the process 300 may be used to prepare and transmit to a UE a handover preparation message with directional information of mmWave frequency beams.

The process 300 may include, at 310, determining positional information of a UE based on a connection between an eNB and the UE in a microwave frequency band, e.g., by eNB 210 of FIG. 2.

In some embodiments, the eNB may determine the positional information of the UE based on one or more 3GPP LTE positioning services, such as the 3GPP positioning mechanisms described in 3GPP Technical Specifications (TS) 23.032, 36.305, 36.355, 36.455. In some embodiments, the eNB may further determine an azimuth angle of the UE in reference to the eNB based on the connection between the eNB and the UE in the microwave frequency band.

The process 300 may further include, at 320, estimating directional information of an mmWave frequency beam to be transmitted from the eNB to the UE based on the positional information, e.g., by eNB 210 of FIG. 2. In some embodiments, the eNB may further estimate a margin angle based on the azimuth angle of the UE to direct the mmWave frequency beam to the UE.

The process 300 may further include, at 330, transmitting a handover preparation message to the UE, e.g., by eNB 210 of FIG. 2. In some embodiments, the handover preparation message may include the directional information to the UE to facilitate a handover of the UE to an mmWave frequency band from the microwave frequency band. In some embodiments, the eNB may transmit a modified RRCConnectionReconfiguration message with information of an mmWave synchronization sequence for the handover. In some embodiments, the eNB may report selected mmWave synchronization information with the UE including a part of the directional information to a neighboring eNB. Thus, the neighboring eNB may avoid directing mmWave beams to the same direction, as an example.

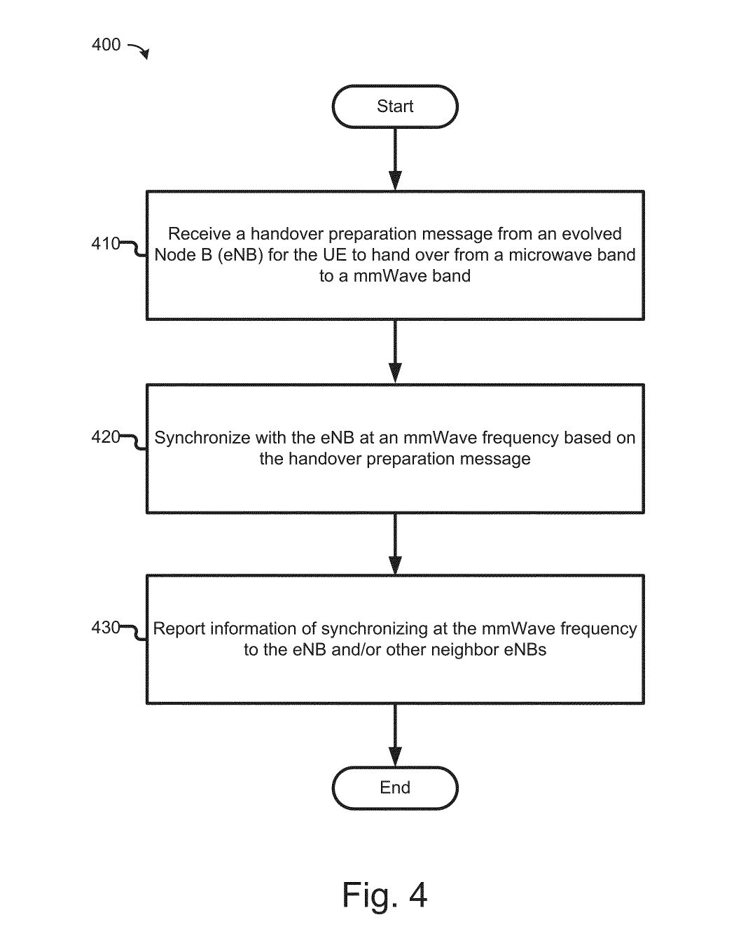

FIG. 4 is a flowchart illustrating another process for network assisted mmWave beam synchronization and alignment in accordance with various embodiments. The process 400 may be performed by a UE, e.g., UE 120 of FIG. 1, or UE 220 of FIG. 2. In various embodiments, the process 400 may facilitate a UE to hand over from a primary carrier frequency to a secondary carrier frequency, e.g., from a microwave band to an mmWave band.

The process 400 may include, at 410, receiving a handover preparation message from an eNB for a UE to hand over from a microwave band to a mmWave band, e.g., by UE 220 of FIG. 2.

In some embodiments, the UE may receive the handover preparation message in an RRCConnectionReconfiguration message with one or more information elements including information of an mmWave synchronization sequence to be transmitted to the UE. In some embodiments, the UE may receive the handover preparation message from a connection between the eNB and the UE in a microwave frequency band. In some embodiments, the handover preparation message may include directional information, in reference to the UE and the eNB, of an mmWave frequency beam with mmWave synchronization signals from the eNB.

The process 400 may further include, at 420, synchronizing with the eNB at an mmWave frequency based on the handover preparation message, e.g., by UE 220 of FIG. 2. In some embodiments, the UE may synchronize with the eNB at the mmWave frequency and align with the eNB at a beam level before releasing the connection in the microwave frequency band.

In some embodiments, the UE may synchronize with the eNB at the mmWave frequency based on information of the mmWave synchronization signals contained in the handover preparation message. In some embodiments, the information of the mmWave synchronization signals may include an azimuth angle of the UE to the eNB, a search space around the azimuth angle for the mmWave frequency beam, a type of synchronization sequence, a plurality of sequence parameters of the synchronization sequence, a time window for the UE to synchronize with the eNB at the mmWave frequency, a time interval of the mmWave synchronization signals, and a frequency of the mmWave synchronization signals.

The process 400 may further include, at 430, reporting information of synchronizing at the mmWave frequency to the eNB and/or other neighbor eNBs, e.g., by UE 220 and/or eNB 210 of FIG. 2. In some embodiments, a UE may inform the respective base station of its synchronization and beam alignment achievement. As an example, the UE may transmit an RRC message indicating to the eNB that synchronization and beam alignment at the mmWave carrier frequency has been achieved. In addition, the UE may indicate the angle of arrival of the mmWave beams to the eNB.

In some embodiments, the eNB may inform the neighbor base stations on the pilot transmission, e.g., via narrow directional beams at mmWave frequency band(s). As an example, the eNB may use X2 application protocol (AP) as specified in 3GPP TS 36.423 to inform the neighbor base stations for such information. For instance, an X2 message, e.g., the “Load Information” (at 3GPP TS 36.423, §8.3.1.2) or the “Resource Status Request (& Response)” (at 3GPP TS 36.423, §8.3.6.2), may be used to report such information. In such reporting, information of sequences for mmWave band synchronization may be included in one or more IEs in the message. In other embodiments, other information, such as angle of departure, mmWave carrier frequency, mmWave beam width, time window of pilot transmission, synchronization sequence characteristics, synchronization sequence transmission pattern, etc., may also be included in the reporting message. In various embodiments, neighbor base stations may use such reporting information to make appropriate decisions. For instance, another base station may avoid directing mmWave synchronization sequences toward the same direction that is specified in the reporting message.

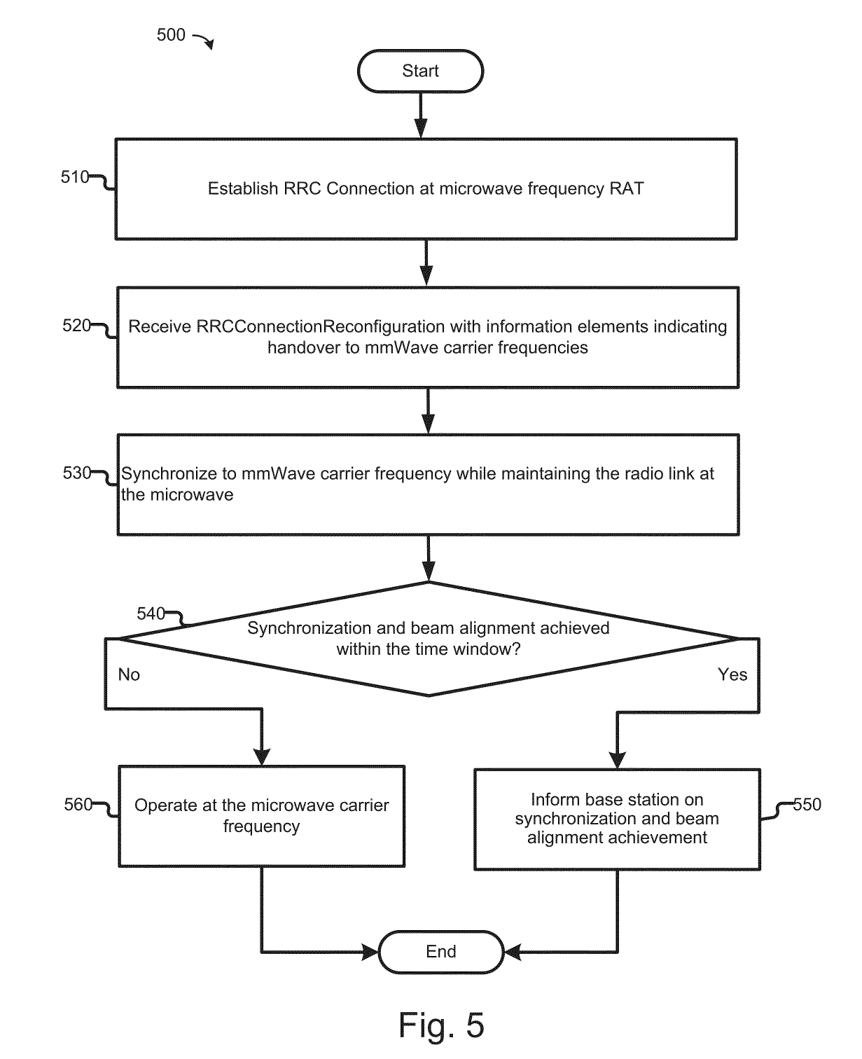

FIG. 5 is a flowchart illustrating yet another process 500 for network assisted mmWave beam synchronization and alignment in accordance with various embodiments. The process 500 may be performed by a UE, e.g., UE 120 of FIG. 1, or UE 220 of FIG. 2. In various embodiments, the process 500 may illustrate an embodiment of process 400 in the 3GPP LTE Advanced by focusing on the wireless device operation.

The process 500 may include, at 510, establishing a radio link with an RRC Connection at microwave frequency RAT, e.g., by UE 220 of FIG. 2. In some embodiments, the UE may enter the RRC connected mode in the RAT operating at microwave carrier frequency, e.g., 3GPP LTE Advanced, having obtained synchronization at this carrier frequency.

The process 500 may further include, at 520, receiving RRCConnectionReconfiguration with information elements indicating handover to mmWave carrier frequencies. In some embodiments, the UE may receive a handover preparation message in the form of the modified RRCConnectionReconfiguration message indicating that the UE should try to synchronize at mmWave frequency band and get beam alignment.

The process 500 may further include, at 530, synchronizing to mmWave carrier frequency while maintaining the radio link at the microwave. In some embodiments, the UE may try to get synchronization and beam alignment at mmWave frequency band by following the indications included in the modified RRCConnectionReconfiguration message. At the same time, the UE may continue the normal operation at the microwave frequency band.

The process 500 may further include, at 540, determining whether synchronization and beam alignment in an mmWave band have been achieved within a preconfigured time window. In some embodiments, the UE may receive information of the preconfigured time window in the IEs in the received RRCConnectionReconfiguration. In other embodiments, the preconfigured time window may be determined by the UE. As an example, a UE may preconfigure a standard time window for synchronization and beam alignment for mmWave carrier frequencies. As another example, a UE may determine the preconfigured time window based on its prior data of synchronization and beam alignment in mmWave frequencies. As yet another example, a UE may inquiry the network (e.g., via an eNB) for parameters of synchronization and beam alignment in the mmWave band including a suggested time window by the network for completing the procedure.

If synchronization and beam alignment in the mmWave band have been achieved within the preconfigured time window, the process 500 may further include, at 550, informing the base station of its synchronization and beam alignment achievement. In some embodiments, after the UE succeeds in getting synchronized and aligned at beam level at mmWave carrier frequency, the UE may transmit an RRC message indicating to the network that synchronization and beam alignment at the mmWave carrier frequency has been achieved. In addition, the UE may indicate the angle of arrival of the mmWave beams to the network. Otherwise, the process 500 may further include, at 560, continuing its operation at the microwave carrier frequency.

The UE 120 of FIG. 1 or UE 220 of FIG. 2 may be implemented into a system using any suitable hardware, firmware, and/or software configured as desired. FIG. 6 illustrates, for one embodiment, an example system 600 includes radio frequency (RF) circuitry 610, baseband circuitry 620, application circuitry 630, memory/storage 640, display 650, camera 660, sensor 670, and input/output (I/O) interface 680, coupled with each other at least as shown.

The application circuitry 630 may include circuitry such as, but not limited to, one or more single-core or multi-core processors. The processor(s) may include any combination of general-purpose processors and dedicated processors (e.g., graphics processors, application processors, etc.). The processors may be coupled with memory/storage 640 and configured to execute instructions stored in the memory/storage 640 to enable various applications and/or operating systems running on the system 600.

The baseband circuitry 620 may include circuitry such as, but not limited to, one or more single-core or multi-core processors. The processor(s) may include a baseband processor. The baseband circuitry 620 may handle various radio control functions that enable communication with one or more radio networks via the RF circuitry 610. The radio control functions may include, but are not limited to, signal modulation, encoding, decoding, radio frequency shifting, etc. In some embodiments, the baseband circuitry 620 may provide for communication compatible with one or more radio technologies. For example, in some embodiments, the baseband circuitry 620 may support communication with an E-UTRAN and/or a wireless metropolitan area network (WMAN), a wireless local area network (WLAN), or a wireless personal area network (WPAN).

Embodiments in which the baseband circuitry 620 is configured to support radio communications of more than one wireless protocol may be referred to as multi-mode baseband circuitry.

In various embodiments, baseband circuitry 620 may include circuitry to operate with signals that are not strictly considered as being in a baseband frequency. For example, in some embodiments, baseband circuitry 620 may include circuitry to operate with signals having an intermediate frequency, which is between a baseband frequency and a radio frequency.

In some embodiments, the processing circuitry 226 of FIG. 2 may be embodied in the application circuitry 630 and/or the baseband circuitry 620.

RF circuitry 610 may enable communication with wireless networks using modulated electromagnetic radiation through a non-solid medium. In various embodiments, the RF circuitry 610 may include switches, filters, amplifiers, etc., to facilitate the communication with the wireless network.

In various embodiments, RF circuitry 610 may include circuitry to operate with signals that are not strictly considered as being in a radio frequency. For example, in some embodiments, RF circuitry 610 may include circuitry to operate with signals having an intermediate frequency, which is between a baseband frequency and a radio frequency.

In some embodiments, the transceiver circuitry 224 of FIG. 2 may be embodied in the RF circuitry 610.

In some embodiments, some or all of the constituent components of the baseband circuitry 620, the application circuitry 630, and/or the memory/storage 640 may be implemented together on a system on a chip (SOC).

Memory/storage 640 may be used to load and store data and/or instructions, for example, for system 600. Memory/storage 640 for one embodiment may include any combination of suitable volatile memory (e.g., dynamic random access memory (DRAM)) and/or non-volatile memory (e.g., flash memory).

In various embodiments, the I/O interface 680 may include one or more user interfaces to enable user interaction with the system 600 and/or peripheral component interfaces to enable peripheral component interaction with the system 600. User interfaces may include, but are not limited to, a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, sensor 670 may include one or more sensing devices to determine environmental conditions and/or location information related to the system 600. In some embodiments, the sensors may include, but are not limited to, a gyro sensor, an accelerometer, a proximity sensor, an ambient light sensor, and a positioning unit. The positioning unit may also be part of, or interact with, the baseband circuitry 620 and/or RF circuitry 610 to communicate with components of a positioning network, e.g., a global positioning system (GPS) satellite.

In various embodiments, the display 650 may include a display, e.g., a liquid crystal display, a touch screen display, etc. In some embodiments, the camera 660 may include many molded plastic aspheric lens elements made with varying dispersion and refractive indexes. In some embodiments, the camera 660 may include two or more lenses to capture three-dimensional images for stereo photography.

In various embodiments, the system 600 may be a mobile computing device such as, but not limited to, a laptop computing device, a tablet computing device, a netbook, an ultrabook, a smartphone, etc. In various embodiments, system 600 may have more or fewer components, and/or different architectures.

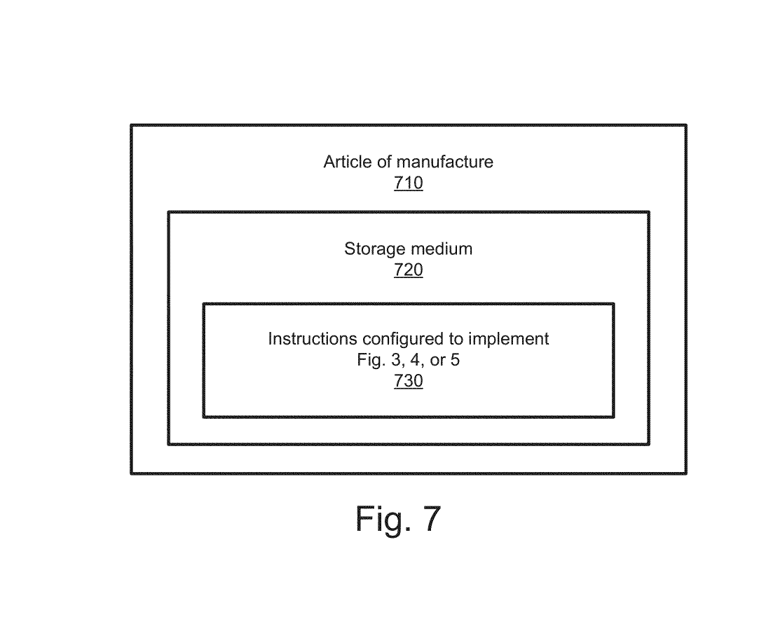

FIG. 7 illustrates an article of manufacture 710 having programming instructions, incorporating aspects of the present disclosure, in accordance with various embodiments. In various embodiments, an article of manufacture may be employed to implement various embodiments of the present disclosure. As shown, the article of manufacture 710 may include a computer-readable non-transitory storage medium 720 where instructions 730 are configured to practice embodiments of or aspects of embodiments of any one of the processes described herein. The storage medium 720 may represent a broad range of persistent storage media known in the art, including but not limited to flash memory, dynamic random access memory, static random access memory, an optical disk, a magnetic disk, etc. In embodiments, computer-readable storage medium 720 may include one or more computer-readable non-transitory storage media. In other embodiments, computer-readable storage medium 720 may be transitory, such as signals, encoded with instructions 730.

In various embodiments, instructions 730 may enable an apparatus, in response to their execution by the apparatus, to perform various operations described herein. As an example, storage medium 720 may include instructions 730 configured to cause an apparatus, e.g., eNB 210 in connection with FIG. 2, to practice some aspects of network assisted mmWave beam synchronization and alignment, e.g., as illustrated in process 300 of FIG. 3, in accordance with embodiments of the present disclosure. As another example, storage medium 720 may include instructions 730 configured to cause an apparatus, e.g., UE 220 in connection with FIG. 2, to practice some aspects of network assisted mmWave beam synchronization and alignment, e.g., as illustrated in process 400 of FIG. 4 or process 500 of FIG. 5, in accordance with embodiments of the present disclosure.

The following paragraphs describe examples of various embodiments.

Example 1 is an evolved Node B (eNB). The eNB may include processing circuitry to estimate directional information of a millimeter wave (mmWave) frequency beam from the eNB in reference to a user equipment (UE) based on positional information of the UE obtained based on a connection between the eNB and the UE in a microwave frequency band; and transceiver circuitry, coupled to the processing circuitry, to send the directional information to the UE.

Example 2 includes the subject matter of example 1, wherein the processing circuitry is further to determine the positional information of the UE based on one or more 3rd Generation Partnership Project (3GPP) Long Term Evolution (LTE) positioning services.

Example 3 includes the subject matter of example 1 or 2, wherein the processing circuitry is further to determine an azimuth angle of the UE in reference to the eNB based on the connection between the eNB and the UE in the microwave frequency band.

Example 4 includes the subject matter of example 3, wherein the processing circuitry is further to determine a margin angle based on the azimuth angle of the UE to direct mmWave synchronization signals to the UE.

Example 5 includes the subject matter of example 4, wherein the processing circuitry is further to generate a handover preparation message including the azimuth angle and the margin angle to the UE to facilitate a handover of the UE to an mmWave carrier frequency.

Example 6 includes the subject matter of example 5, wherein the processing circuitry is to modify an RRCConnectionReconfiguration message to be transmitted to the UE to include the handover preparation message in one or more information elements of the RRCConnectionReconfiguration message, and wherein the handover preparation message includes information of an mmWave synchronization sequence to be transmitted to the UE.

Example 7 includes the subject matter of any one of examples 1-6, wherein the transceiver circuitry is further to send another eNB of selected mmWave synchronization information with the UE including at least a part of the directional information.

Example 8 is a method for network assisted mmWave beam synchronization and alignment. The method may include determining positional information of a user equipment (UE) based on a connection between an eNB and the UE in a microwave frequency band; estimating directional information of an mmWave frequency beam to be transmitted from the eNB to the UE based on the positional information; and transmitting a handover preparation message including the directional information to the UE to facilitate a handover of the UE to an mmWave frequency band from the microwave frequency band.

Example 9 includes the subject matter of example 8, and wherein determining positional information comprises determining the positional information of the UE based on one or more 3GPP LTE positioning services.

Example 10 includes the subject matter of example 8 or 9, and wherein determining positional information comprises determining an azimuth angle of the UE in reference to the eNB based on the connection between the eNB and the UE in the microwave frequency band.

Example 11 includes the subject matter of example 10, and wherein estimating directional information comprises estimating a margin angle based on the azimuth angle of the UE to direct the mmWave frequency beam to the UE.

Example 12 includes the subject matter of any one of examples 8-11, wherein transmitting a handover preparation message comprises transmitting a modified RRCConnectionReconfiguration message with information of an mmWave synchronization sequence for the handover.

Example 13 includes the subject matter of any one of examples 8-12, further includes transmitting selected mmWave synchronization information with the UE including a part of the directional information to another eNB.

Example 14 is at least one storage medium having instructions configured to cause an apparatus, in response to execution of the instructions by the apparatus, to practice any subject matter of Examples 8-12.

Example 15 is an apparatus for wireless communication, which may include means to practice any subject matter of Examples 8-12.

Example 16 is a user equipment (UE). The UE may include transceiver circuitry to receive an RRCConnectionReconfiguration message with one or more information elements including mmWave synchronization information from an evolved Node B (eNB) for the UE to hand over from a microwave band to an mmWave band; and processing circuitry coupled to the transceiver circuitry to synchronize with the eNB at an mmWave frequency based on the mmWave synchronization information.

Example 17 includes the subject matter of example 16, wherein the transceiver circuitry is to receive a handover preparation message in the RRCConnectionReconfiguration message with directional information of an mmWave frequency beam to be transmitted to the UE from the eNB.

Example 18 includes the subject matter of example 17, wherein the mmWave frequency beam comprises mmWave synchronization signals from the eNB

Example 19 includes the subject matter of any one of examples 16-18, wherein the mmWave synchronization information comprises one or more of an azimuth angle of the UE to the eNB, a search space around the azimuth angle for the mmWave frequency beam, a type of synchronization sequence, a plurality of sequence parameters of the synchronization sequence, a time window for the UE to synchronize with the eNB at the mmWave frequency, a time interval of the mmWave synchronization signals, or a frequency of the mmWave synchronization signals.

Example 20 includes the subject matter of any one of examples 16-19, wherein the transceiver circuitry is to receive the RRCConnectionReconfiguration message from a connection between the eNB and the UE in a microwave frequency band, and wherein the processing circuitry is to synchronize with the eNB at the mmWave frequency and align with the eNB at a beam level before releasing the connection in the microwave frequency band.

Example 21 includes the subject matter of any one of examples 16-20, wherein the transceiver circuitry is further to transmit a Radio Resource Control (RRC) message to the eNB to indicate whether a synchronization and beam alignment at the mmWave frequency is achieved.

Example 22 is a method for network assisted mmWave beam synchronization and alignment. The method may include receiving a handover preparation message with directional information of an mmWave frequency beam from an evolved Node B (eNB) for a UE to hand over from a microwave band to an mmWave band; and synchronizing with the eNB at an mmWave frequency based on the handover preparation message.

Example 23 includes the subject matter of example 22, and may further include receiving the handover preparation message in an RRCConnectionReconfiguration message with one or more information elements including information of an mmWave synchronization sequence to be transmitted to the UE.

Example 24 includes the subject matter of example 22 or 23, and may further include receiving the handover preparation message from a connection between the eNB and the UE in a microwave frequency band, and wherein the handover preparation message comprises directional information, in reference to the UE and the eNB, of an mmWave frequency beam with mmWave synchronization signals from the eNB.

Example 25 includes the subject matter of any one of examples 22-24, and may further include synchronizing with the eNB at the mmWave frequency based on information of the mmWave synchronization signals contained in the handover preparation message, wherein the information of the mmWave synchronization signals comprises one or more of an azimuth angle of the UE to the eNB, a search space around the azimuth angle for the mmWave frequency beam, a type of synchronization sequence, a plurality of sequence parameters of the synchronization sequence, a time window for the UE to synchronize with the eNB at the mmWave frequency, a time interval of the mmWave synchronization signals, and a frequency of the mmWave synchronization signals.

Example 26 includes the subject matter of any one of examples 22-25, and may further include synchronizing with the eNB at the mmWave frequency and aligning with the eNB at a beam level before releasing the connection in the microwave frequency band.

Example 27 includes the subject matter of any one of examples 22-26, and may further include transmitting a Radio Resource Control (RRC) message to the eNB to indicate whether a synchronization and beam alignment at the mmWave frequency is achieved.

Example 28 is at least one storage medium having instructions configured to cause an apparatus, in response to execution of the instructions by the apparatus, to practice any subject matter of Examples 22-27.

Example 29 is an apparatus for wireless communication, which may include means to practice any subject matter of Examples 22-27.

The description herein of illustrated implementations, including what is described in the Abstract, is not intended to be exhaustive or to limit the present disclosure to the precise forms disclosed. While specific implementations and examples are described herein for illustrative purposes, a variety of alternate and/or equivalent embodiments or implementations calculated to achieve the same purposes may be made in light of the above detailed description, without departing from the scope of the present disclosure, as those skilled in the relevant art will recognize.

What is claimed is:

1. An evolved Node B (eNB), comprising:
processing circuitry to estimate directional information of a millimeter wave (mmWave) frequency beam from the eNB in reference to a user equipment (UE) based on positional information of the UE obtained based on a connection between the eNB and the UE in a microwave frequency band; and
transceiver circuitry, coupled to the processing circuitry, to send the directional information to the UE.

2. The eNB of claim 1, wherein the processing circuitry is further to determine the positional information of the UE based on one or more 3rd Generation Partnership Project (3GPP) Long Term Evolution (LTE) positioning services.

3. The eNB of claim 1, wherein the processing circuitry is further to determine an azimuth angle of the UE in reference to the eNB based on the connection between the eNB and the UE in the microwave frequency band.

4. The eNB of claim 3, wherein the processing circuitry is further to determine a margin angle based on the azimuth angle of the UE to direct mmWave synchronization signals to the UE.

5. The eNB of claim 4, wherein the processing circuitry is further to generate a handover preparation message including the azimuth angle and the margin angle to the UE to facilitate a handover of the UE to an mmWave carrier frequency.

6. The eNB of claim 5, wherein the processing circuitry is further to modify an RRCConnectionReconfiguration message to be transmitted to the UE to include the handover preparation message in one or more information elements of the RRCConnectionReconfiguration message, and wherein the handover preparation message includes information of an mmWave synchronization sequence to be transmitted to the UE.

7. The eNB of claim 1, wherein the transceiver circuitry is further to send another eNB of selected mmWave synchronization information with the UE including at least a part of the directional information.

8. A method, comprising:
determining positional information of a user equipment (UE) based on a connection between an eNB and the UE in a microwave frequency band;
estimating directional information of an mmWave frequency beam to be transmitted from the eNB to the UE based on the positional information; and
transmitting a handover preparation message including the directional information to the UE to facilitate a handover of the UE to an mmWave frequency band from the microwave frequency band.

9. The method of claim 8, wherein determining positional information comprises determining the positional information of the UE based on one or more 3GPP LTE positioning services.

10. The method of claim 8, wherein determining positional information comprises determining an azimuth angle of the UE in reference to the eNB based on the connection between the eNB and the UE in the microwave frequency band.

11. The method of claim 10, wherein estimating directional information comprises estimating a margin angle based on the azimuth angle of the UE to direct the mmWave frequency beam to the UE.

12. The method of claim 8, wherein transmitting a handover preparation message comprises transmitting a modified RRCConnectionReconfiguration message with information of an mmWave synchronization sequence for the handover.

13. The method of claim 8, further comprising:
transmitting selected mmWave synchronization information with the UE including a part of the directional information to another eNB.

14. A user equipment (UE), comprising:
transceiver circuitry to receive an RRCConnectionReconfiguration message with one or more information elements including mmWave synchronization information from an evolved Node B (eNB) for the UE to hand over from a microwave band to an mmWave band; and
processing circuitry coupled to the transceiver circuitry to synchronize with the eNB at an mmWave frequency based on the mmWave synchronization information.

15. The UE of claim 14, wherein the transceiver circuitry is to receive a handover preparation message in the RRCConnectionReconfiguration message with directional information of an mmWave frequency beam to be transmitted to the UE from the eNB, and wherein the mmWave frequency beam comprises mmWave synchronization signals from the eNB.

16. The UE of claim 14, wherein the mmWave synchronization information comprises one or more of an azimuth angle of the UE to the eNB, a search space around the azimuth angle for the mmWave frequency beam, a type of synchronization sequence, a plurality of sequence parameters of the synchronization sequence, a time window for the UE to synchronize with the eNB at the mmWave frequency, a time interval of the mmWave synchronization signals, or a frequency of the mmWave synchronization signals.

17. The UE of claim 14, wherein the transceiver circuitry is to receive the RRCConnectionReconfiguration message from a connection between the eNB and the UE in a microwave frequency band.

18. The UE of claim 17, wherein the processing circuitry is to synchronize with the eNB at the mmWave frequency and align with the eNB at a beam level before releasing the connection in the microwave frequency band.

19. The UE of claim 14, wherein the transceiver circuitry is further to transmit a Radio Resource Control (RRC) message to the eNB to indicate whether a synchronization and beam alignment at the mmWave frequency is achieved.

20. One or more non-transitory computer-readable media having instructions that, when executed, cause a transmitting user equipment (UE) to:
receive a handover preparation message with directional information of an mmWave frequency beam from an evolved Node B (eNB) for the UE to hand over from a microwave band to an mmWave band; and
synchronize with the eNB at an mmWave frequency based on the handover preparation message.

21. The one or more non-transitory computer-readable media of claim 20, wherein the instructions, when executed, further cause the transmitting UE to:
receive the handover preparation message in a RRCConnectionReconfiguration message with one or more information elements including information of an mmWave synchronization sequence to be transmitted to the UE.

22. The one or more non-transitory computer-readable media of claim 20, wherein the instructions, when executed, further cause the transmitting UE to:
receive the handover preparation message from a connection between the eNB and the UE in a microwave frequency band, and wherein the handover preparation message comprises directional information, in reference to the UE and the eNB, of an mmWave frequency beam with mmWave synchronization signals from the eNB.

23. The one or more non-transitory computer-readable media of claim 22, wherein the instructions, when executed, further cause the transmitting UE to:
synchronize with the eNB at the mmWave frequency based on information of the mmWave synchronization signals contained in the handover preparation message, wherein the information of the mmWave synchronization signals comprises one or more of an azimuth angle of the UE to the eNB, a search space around the azimuth angle for the mmWave frequency beam, a type of synchronization sequence, a plurality of sequence parameters of the synchronization sequence, a time window for the UE to synchronize with the eNB at the mmWave frequency, a time interval of the mmWave synchronization signals, and a frequency of the mmWave synchronization signals.

24. The one or more non-transitory computer-readable media of claim 22, wherein the instructions, when executed, further cause the transmitting UE to:
synchronize with the eNB at the mmWave frequency and align with the eNB at a beam level before releasing the connection in the microwave frequency band.

25. The one or more non-transitory computer-readable media of claim 20, wherein the instructions, when executed, further cause the transmitting UE to:
transmit a Radio Resource Control (RRC) message to the eNB to indicate whether a synchronization and beam alignment at the mmWave frequency is achieved.
